(19) United States
(12) Patent Application Publication
(10) Pub. No.: US 2004/0226609 A1
(43) Pub. Date: Nov. 18, 2004

(54) Valve having integrally cast end connections

(76) Inventor: Ali Marandi, Irvine, CA (US)

Correspondence Address: Boniard I. Brown, #113, 1500 West Covina Parkway, West Covina, CA, 91790-2793, US

(21) Appl. No.: 10/439,102

(22) Filed: May 15, 2003

(51) Int. Cl. F16L 5/00

(52) U.S. Cl. 137/364

(57) ABSTRACT

A valve and an adjacent bell end and/or spigot components are integrally formed, whereby separating forces are resisted. A pipe sleeve may extend from a shroud atop the valve to a ground surface level for access to the valve.

### BACKGROUND AND SUMMARY OF THE INVENTION

In fields such as irrigation, there has long been the problem of preventing separation of valves from other components caused by changes in water pressure, opening or closing the valve, and outside forces. In utilization of bell end and spigot valving arrangements, the problem is well known. To prevent valve and pipe separation, concrete thrust blocks have long been utilized, requiring substantial labor and expense to mold concrete thrust blocks in place, or otherwise. Mechanical joint restraints have also been utilized to secure a valve with other components.

The present invention provides means for preventing separation of valves from spigots without involving any thrust blocks or special mechanical restraint devices, particularly with bell and spigot type valves.

The separation of valves from other components can be caused by changes in water pressure, as upon the closing off or opening of a valve, by outside forces, etc.

The present invention provides an assembly wherein a valve housing is integrally formed or cast with bell end or a spigot, typically. “Bell end” is the term in the art for a component having a generally arcuate or rounded end portion adapted to receive the end of a spigot which is an unthreaded pipe end adapted to fit in the bell end.

The present invention may be utilized with a wide variety of valves, including gate valves, globe valves, angle valves, butterfly valves, ball valves, and control valves.

The present invention also relates to the provision of the above-mentioned combinations with a shroud disposed atop the valve and generally coaxial with a valve operator shaft, together with a pipe sleeve within and generally concentric with the valve operator to extend upwardly toward a ground surface to provide access to the valve operator.

### BRIEF DESCRIPTION OF THE DRAWINGS

FIG. 1 is a top view of a valve with a bell end member and a spigot integrally formed therewith, the view of FIG. 1 being taken at line 1-1 in FIG. 5;

FIG. 2 is an elevational view of a valve housing integrally formed with a bell end on its input side and a bell end on its output side;

FIG. 3 is an elevational view of a valve housing integrally formed with a bell end on its input side and a spigot on its output side;

FIG. 4 is an elevational view of a central valve housing integrally formed with a spigot on its inlet side and a spigot at its outlet side;

FIG. 5 shows an underground valve with components integrally formed thereon and a shroud having an upwardly extending pipe sleeve for access to the valve;

FIG. 6 is a sectional view of a shroud utilized with the apparatus of FIG. 5;

FIG. 7 is a sectional view taken at line 7-7 in FIG. 6; and

FIG. 8 is a sectional view taken at line 8-8 in FIG. 5.

### DESCRIPTION OF THE PREFERRED EMBODIMENTS

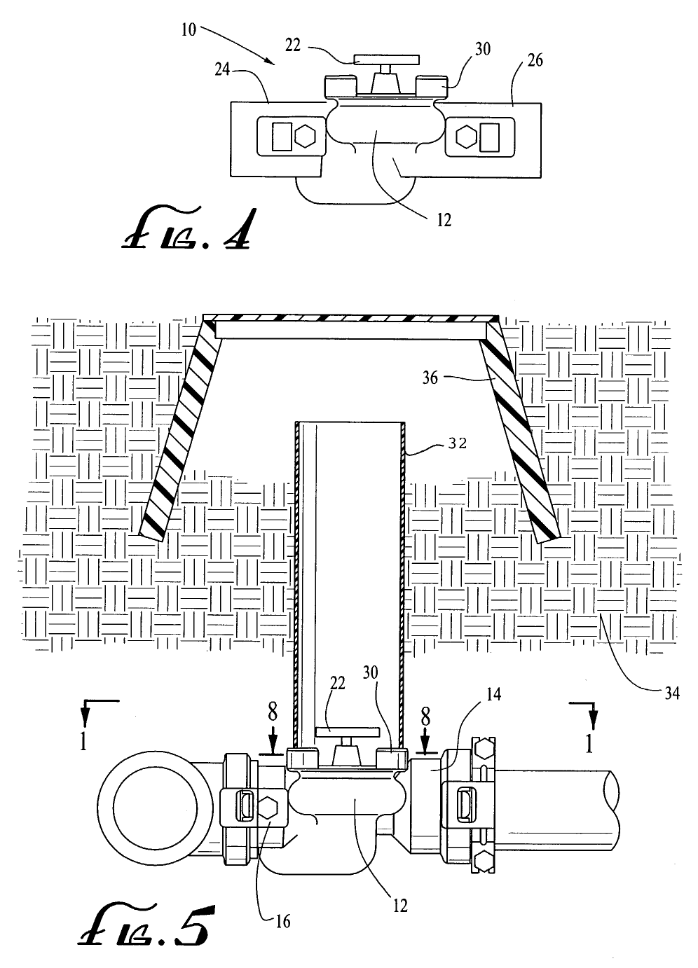

Referring to the drawings, an assembly 10 comprises a central valve housing 12 which is integrally cast with interconnections with and housings of a bell end 14 on an output side of the valve and a second bell end 16 on the input side of the valve. A pipe or spigot 18 has its end portion disposed in bell end 14. The housing 12 of the valve is integrally cast and formed with interconnections or housings of the bell ends 14, 16. There is thus provided effective restraint against separation of the valve from either of the bell ends, as would otherwise occur as result of changes in the flow or stoppage of flow through the valve or by other forces, such as outside forces. Separation is thus prevented as between a first component on an input side of the valve and a second component on the output side of the valve. The integrally cast interconnections between the first member on the input side and second member on the outlet side effectively prevent separation of the valve housing from the first and second members. These components may be utilized in different combinations. These include the bell end 14 and spigot 24 of FIG. 3, with the spigot 24 being on the input side of the valve and bell 14 being on the output side. FIG. 4 shows a central valve and housing 12 to which are integrally molded the housing or portion of spigot 24 on the input side of the valve and a spigot 26 on the output side of the valve, as shown.

A wide variety of valves may be utilized with the valve housing 12, including globe valves, gate valves, angle valves, plug valves, butterfly valves, ball valves, and control valves.

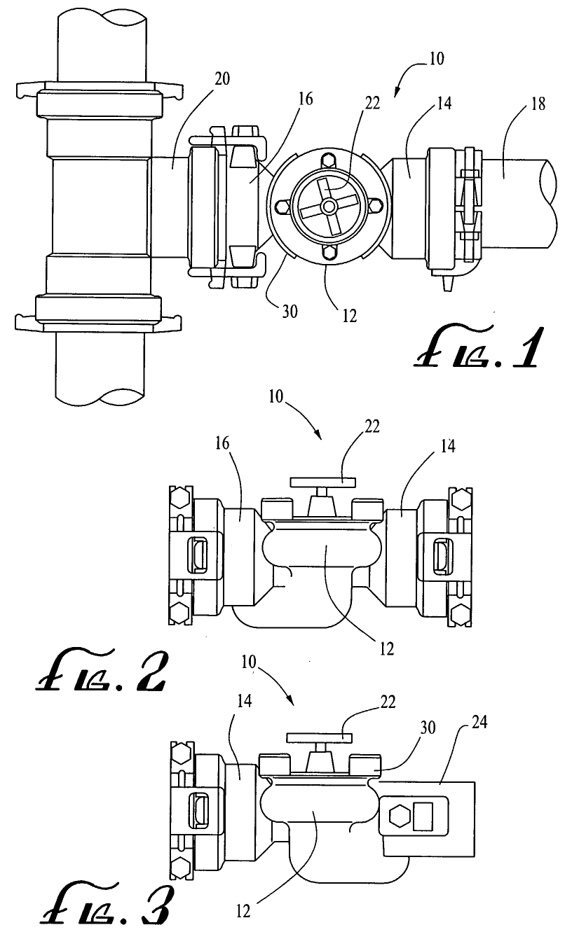

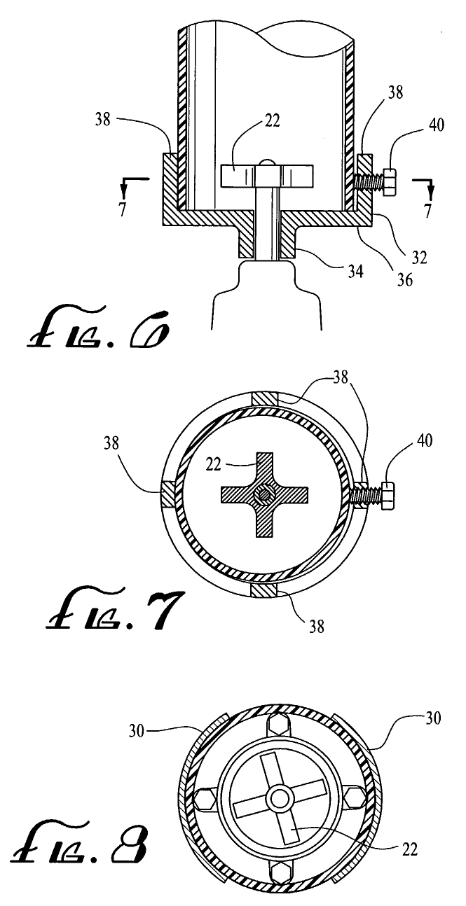

Referring to FIG. 5, an assembly similar to that of FIG. 1 is shown disposed underground or under gravel 34. The valve operator or handle 22 is atop the valve, and shroud 30 is disposed atop the valve, as shown. The shroud may be molded integrally with the valve housing, as shown in FIG. 5, or may comprise a plurality of upwardly extending bars or fingers 38, as shown in FIG. 7. A pipe sleeve 32 is positioned and centered by the shroud. The pipe lower end portion is preferably sized to fit closely within the shroud 30. Alternatively, a set screw 40 may be utilized to retain the pipe sleeve in the shroud, as indicated in FIG. 6. The shroud serves to center the pipe sleeve relative to the valve operator 22.

A cover 36 is preferably provided and disposed with its skirt portion inserted into the ground or gravel, as shown, and preferably with an upper surface flush with the upper surface of the ground, as shown. It is readily removable for access to pipe sleeve 32. There is thus provided immediate access via the pipe sleeve for operation of the valve handle or operator 22.

It will be understood that various changes and modifications may be made from the preferred embodiments discussed above without departing from the scope of the present invention, which is established by the following claims and equivalents thereof.

The inventor claims:

1. An integrally cast combination comprising a valve housing and adjacent interconnected components, comprising:
a valve housing integrally cast with an interconnection with a first member on the inlet side of the valve housing, and
said valve housing being integrally cast with an interconnection with a second member on the outlet side of the valve housing,
whereby separation of said valve housing and said first and second members is substantially prevented.

2. A combination according to claim 1, wherein the first member comprises a bell end, and the second member comprises a bell end.

3. A combination according to claim 1, wherein said first member comprises a bell end to receive a pipe, and
said second member comprises a spigot.

4. A combination according to claim 1, wherein said first member is a spigot, and
said second member comprises a bell end.

5. A combination according to claim 1, wherein said first member comprises a spigot, and
said second member comprises a spigot.

6. A combination according to claim 1, wherein said valve housing has therein a bell and spigot type valve which is one of (a) globe valve, (b) gate valve, (c) an angle valve.

7. A combination according to claim 1, wherein said valve housing contains one of (a) a plug valve, (b) a butterfly valve, (c) a ball valve, (d) a control valve.

8. A combination according to claim 1, and further comprising:
a valve operator handle disposed below a ground surface,
a shroud disposed atop the valve operator and substantially coaxial with a shaft of the valve operator, and
a pipe sleeve adapted to fit within and concentric with generally circular wall means of the shroud to extend upwardly toward a ground surface to provide access to the valve operator.

9. Apparatus according to claim 8, wherein said shroud is formed integrally with the valve housing.

10. Apparatus according to claim 8, wherein said shroud is a member separate from the valve housing.

11. Apparatus according to claim 8, wherein the shroud has a central portion disposed about a shaft of the valve operator and extending upwardly about a lower portion of the pipe sleeve.

12. Apparatus according to claim 8, wherein the shroud comprises a plurality of upwardly extending spaced-apart portions.
